(19) United States
(12) Patent Application Publication
(10) Pub. No.: US 2026/0210780 A1
(43) Pub. Date: Jul. 23, 2026

(54) STRESS AND STRAIN DETECTION DEVICE STACKED IN COMPLEX LAYERS AND MANUFACTURING METHOD THEREOF

(71) Applicant: KOREA RESEARCH INSTITUTE OF STANDARDS AND SCIENCE, Daejeon (KR)

(72) Inventors: Moo Kyum KIM, Daejeon (KR); Min Seok KIM, Daejeon (KR); Seong Gu HONG, Daejeon (KR)

(21) Appl. No.: 19/228,955

(22) Filed: Jun. 5, 2025

(30) Foreign Application Priority Data
Jan. 23, 2025 (KR) 10-2025-0010379

(51) Int. Cl. G01L 1/16; G01L 1/22

(52) U.S. Cl. CPC G01L 1/16; G01L 1/2287

(57) ABSTRACT

A stress and strain detection device includes: a stress sensing layer; a stress sensing pattern positioned on the stress sensing layer; an interlayer separation film covering the stress sensing pattern; a strain sensing pattern positioned on the interlayer separation film; and a protective layer that isolates the strain sensing pattern from the external environment, wherein the stress and strain detection device has flexibility.

### CROSS-REFERENCE TO RELATED APPLICATIONS

This application claims priority to and the benefit of Korean Patent Application No. 10-2025-0010379, filed on Jan. 23, 2025, the entire contents of which are hereby incorporated by reference.

### BACKGROUND

Stress and strain are important physical quantities in various industrial and research fields, requiring technology that simultaneously and precisely measures both in areas such as wearable devices, biometric sensors, robotics, and electronic skin. Existing sensor technologies have primarily focused on measuring either strain or stress alone, requiring separate devices to detect both physical quantities simultaneously. This has led to problems of increased sensor size and manufacturing process complexity. The conventional method of separately manufacturing integrated devices that measure both stress and strain simultaneously is complex, and furthermore, it has been difficult to implement flexible devices.

One of the objectives that this disclosure aims to solve is to address the difficulties of the conventional technologies described above.

### SUMMARY

According to one aspect, a method of forming a stress and strain detection device includes: forming a stress sensing layer on a substrate; forming a stress sensing pattern on the stress sensing layer; forming an interlayer separation film; forming a strain sensing pattern on the interlayer separation film; forming a passivation layer that isolates the strain sensing pattern from the external environment; and separating the substrate.

According to one aspect, the substrate is a light-transmitting substrate, and the step of separating the substrate is performed by providing energy to the side of the light-transmitting substrate opposite to the side where the stress sensing pattern and the strain sensing pattern are formed.

According to one aspect, the light-transmitting substrate is one of a glass substrate, a sapphire substrate, a quartz substrate, a boron substrate, and a polycarbonate substrate, and the step of separating the substrate is performed by irradiating a laser onto the opposite side.

According to one aspect, the stress sensing layer includes a piezoelectric material that forms a voltage differential when pressure is applied, and the piezoelectric material is one or more of: lead zirconium titanate (PZT) (Pb(Zr,Ti)O₃), barium titanate (BaTiO₃), polyvinylidene fluoride (PVDF), zinc oxide (ZnO), lithium niobate (LiNbO₃), lithium tantalate (LiTaO₃), lead titanate (PbTiO₃), titanium oxide (TiO₂), strontium titanate (SrTiO₃), and aluminum nitride (AlN).

According to one aspect, the stress sensing pattern includes interdigitated first finger patterns and second finger patterns, a first pad connected to the first finger pattern, and a second pad connected to the second finger pattern.

According to one aspect, the method of forming the stress and strain detection device further includes applying voltage to align electric dipoles contained in the stress sensing layer to activate piezoelectric properties.

According to one aspect, the strain sensing pattern includes one or more of a silicon nano-membrane pattern, a silicon carbide (SiC) pattern, a molybdenum disulfide (MoS₂) pattern, gallium nitride (GaN), a graphene pattern, a metal oxide pattern, and a metal pattern.

According to one aspect, the step of forming the strain sensing pattern includes forming a hole in a silicon-on-insulator (SOI) substrate with a silicon nano-membrane, wet-etching the silicon-on-insulator substrate with the hole to separate the silicon nano-membrane, and transferring the separated silicon nano-membrane to the interlayer separation film.

According to one aspect, the step of forming the strain sensing pattern is performed after forming the interlayer separation film, before the interlayer separation film is fully cured.

According to one aspect, the step of forming the stress sensing layer includes performing a sintering process to crystallize the piezoelectric material.

According to one aspect, the method of forming the stress and strain detection device further includes forming a protective layer on the exposed stress sensing layer.

According to one aspect, the step of forming the stress sensing pattern on the stress sensing layer is performed by arranging a plurality of the stress sensing patterns in directions perpendicular to each other.

According to one aspect, the step of forming the stress sensing pattern on the stress sensing layer is performed by arranging a plurality of the stress sensing patterns in an array.

According to one aspect, a stress and strain detection device includes: a stress sensing layer; a stress sensing pattern positioned on the stress sensing layer; an interlayer separation film covering the stress sensing pattern; a strain sensing pattern positioned on the interlayer separation film; and a protective layer that isolates the strain sensing pattern from the external environment, wherein the stress and strain detection device has flexibility.

According to one aspect, the stress sensing layer is a piezoelectric material layer that forms a voltage differential when pressure is applied, and the piezoelectric material is one or more of: lead zirconium titanate (PZT), barium titanate (BaTiO₃), polyvinylidene fluoride (PVDF), zinc oxide (ZnO), lithium niobate (LiNbO₃), lithium tantalate (LiTaO₃), lead titanate (PbTiO₃), titanium oxide (TiO₂), strontium titanate (SrTiO₃), and aluminum nitride (AlN).

According to one aspect, the stress sensing pattern includes interdigitated first finger patterns and second finger patterns, a first pad connected to the first finger pattern, and a second pad connected to the second finger pattern.

According to one aspect, the strain sensing pattern is one of a silicon nano-membrane pattern, a silicon carbide (SiC) pattern, a molybdenum disulfide (MoS₂) pattern, gallium nitride (GaN), a graphene pattern, a metal oxide pattern, and a metal pattern.

According to one aspect, the strain sensing pattern is formed by being transferred from a silicon-on-insulator (SOI) substrate.

According to one aspect, the stress and strain detection device further includes a protective layer that seals the exposed surface of the stress sensing pattern.

According to one aspect, the stress sensing layer is formed of crystallized piezoelectric material.

According to one aspect, the stress sensing layer includes piezoelectric material in which electric dipoles are aligned by an applied voltage to activate piezoelectric properties.

According to one aspect, the interlayer separation film and the protective layer are the same material layer.

According to one aspect, the strain sensing pattern has a plurality of strain sensing patterns arranged in directions perpendicular to each other.

According to one aspect, the strain sensing pattern has a plurality of strain sensing patterns arranged in an array.

### BRIEF DESCRIPTION OF THE DRAWINGS

FIG. 1 is a process flow diagram of a method of forming a stress and strain detection device according to an embodiment.

FIG. 2 is a cross-sectional view of a substrate with a stress sensing layer formed according to an embodiment of the method of forming a stress and strain detection device.

FIG. 3 is a top view showing a state in which a stress sensing pattern including a first finger pattern and a second finger pattern is formed on a stress sensing layer.

FIG. 4 is a cross-sectional view cut along line A-A of FIG. 3.

FIG. 5 is a cross-sectional view illustrating a state in which an interlayer separation film is formed on top of a stress sensing pattern.

FIG. 6 is a schematic view illustrating electric dipoles located in the stress sensing layer between the first finger pattern and the second finger pattern.

FIGS. 7A and 7B are top views illustrating states in which a strain sensing pattern is formed on the surface of an interlayer separation film.

FIG. 8 is a cross-sectional view taken along line B-B of FIG. 7A.

FIG. 9 is a view illustrating a process of forming a strain sensing pattern.

FIGS. 10A and 10B are views illustrating states in which a plurality of strain sensing patterns are arranged.

FIG. 11 is a schematic cross-sectional view illustrating a step of forming a protective layer that seals a strain sensing pattern.

FIG. 12 is a view illustrating a process of separating a substrate and a structure formed on the substrate.

FIG. 13 is a cross-sectional view illustrating an example of a stress and strain detection device.

### DETAILED DESCRIPTION

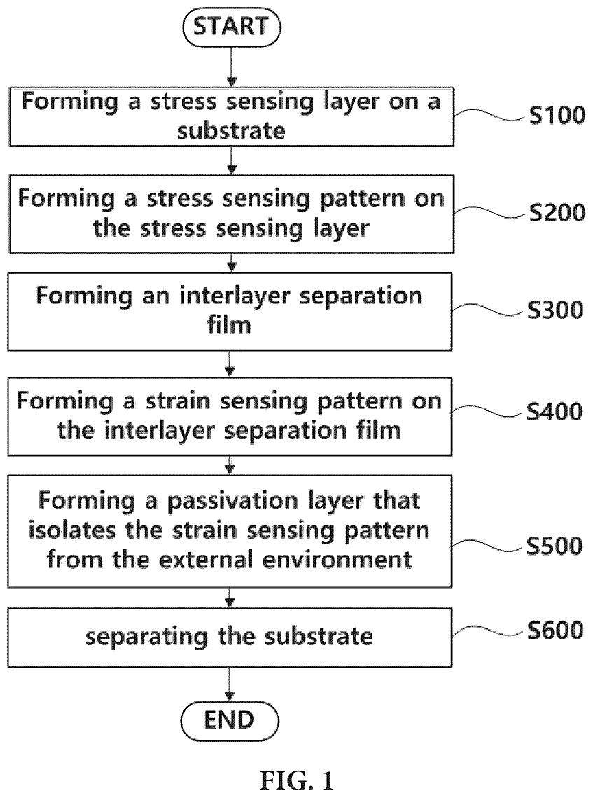

Hereinafter, embodiments will be described with reference to the attached drawings. FIG. 1 is a process flow diagram of a method of forming a stress and strain detection device according to an embodiment. Referring to FIG. 1, the method of forming a stress and strain detection device according to the embodiment includes: forming a stress sensing layer 100 on a substrate (S100); forming a stress sensing pattern on the stress sensing layer (S200); forming an interlayer separation film (S300); forming a strain sensing pattern on the interlayer separation film (S400); forming a passivation layer that isolates the strain sensing pattern from the external environment (S500); and separating the substrate (S600).

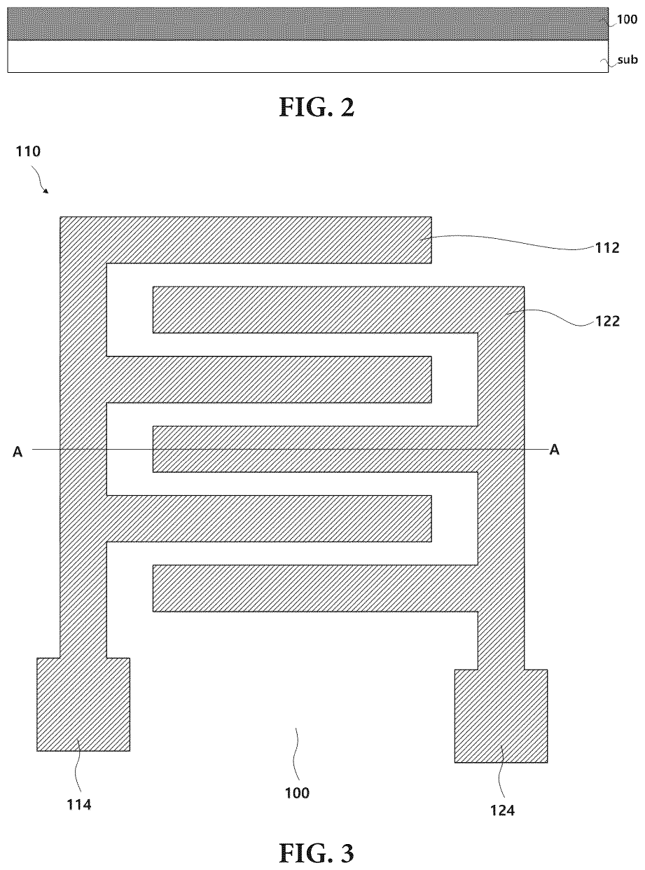

FIG. 2 is a cross-sectional view of a substrate with a stress sensing layer 100 formed according to an embodiment of the method of forming a stress and strain detection device. Referring to FIG. 2, a stress sensing layer 100 is formed on a substrate sub.

In one embodiment, the substrate sub may be any one of a glass substrate, a sapphire substrate, a quartz substrate, a boron substrate, or a polycarbonate substrate, and may be a light-transmitting substrate.

In one embodiment, the stress sensing layer 100 may be a layer made of piezoelectric material, and for example, the piezoelectric material may be one or more of lead zirconium titanate (PZT), barium titanate (BaTiO₃), polyvinylidene fluoride (PVDF), zinc oxide (ZnO), lithium niobate (LiNbO₃), lithium tantalate (LiTaO₃), lead titanate (PbTiO₃), titanium oxide (TiO₂), strontium titanate (SrTiO₃), and aluminum nitride (AlN).

In one embodiment, the step of forming the stress sensing layer 100 may be performed by spin-coating piezoelectric material in a sol-gel state. For example, spin coating may be performed at a rotation speed of 1000 rpm to 5000 rpm.

In one embodiment, a sintering process is performed after forming the stress sensing layer 100 to crystallize the piezoelectric material constituting the stress sensing layer 100. The sintering process may be performed in a range of 300° C. to 1500° C.

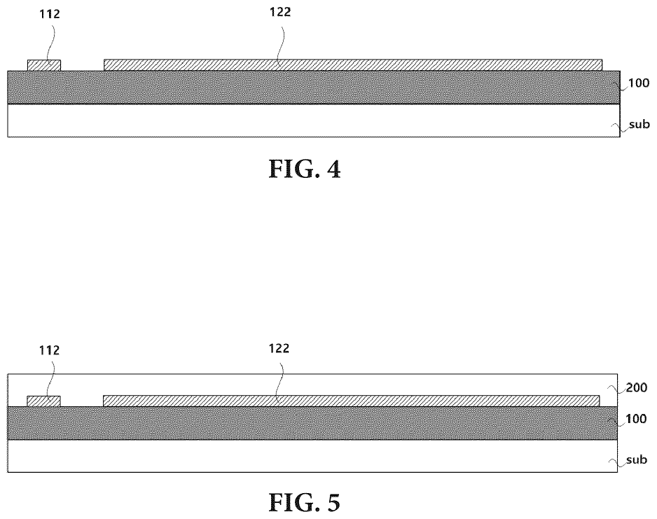

FIG. 3 is a top view showing a state in which a stress sensing pattern 110 including a first finger pattern 112 and a second finger pattern 122 is formed on a stress sensing layer 100, and FIG. 4 is a cross-sectional view cut along line A-A of FIG. 3. Referring to FIGS. 3 and 4, in one embodiment, the stress sensing pattern 100 may be formed by performing a step of forming a conductive metal layer such as gold, silver, copper, platinum, chromium, aluminum, titanium, or nickel, and a step of patterning the conductive metal layer through a semiconductor photo process.

The metal thin film layer may be formed by, for example, one or more methods among physical vapor deposition (PVD) including thermal evaporation, e-beam evaporation, and sputtering; chemical vapor deposition (CVD) including low pressure chemical vapor deposition (LPCVD), metal organic chemical vapor deposition (MOCVD), and plasma enhanced chemical vapor deposition (PECVD); and electrospinning, inkjet printing, spin coating, and spray coating.

The step of patterning the metal thin film layer may be performed through a photo process of a semiconductor process.

In one embodiment, the stress sensing pattern 110 includes interdigitated first finger patterns 112 and second finger patterns 122. The first finger pattern 112 is electrically connected to a first pad 114, and the second finger pattern 122 is electrically connected to a second pad 124.

FIG. 5 is a cross-sectional view illustrating a state in which an interlayer separation film 200 is formed on top of a stress sensing pattern 100. Referring to FIG. 5, an interlayer separation film 200 is formed on the upper layer of the stress sensing pattern 100. In one embodiment, the interlayer separation film 200 may be formed as a layer of one or more of polyimides, polydimethylsiloxane, polymethyl methacrylate, polyurethane, or photoresist. The interlayer separation film 200 may be formed by performing spin coating or the like with a material in fluid state on a substrate with the stress sensing pattern 100 formed thereon.

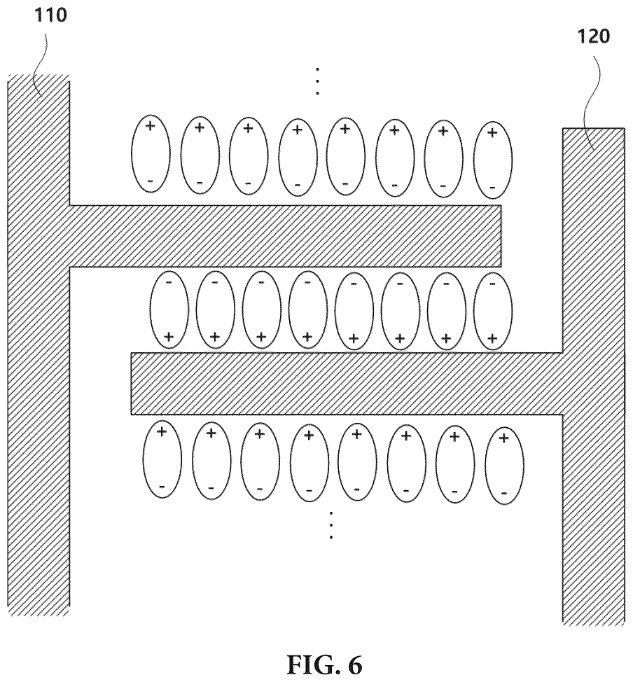

FIG. 6 is a schematic view illustrating electric dipoles located in the stress sensing layer 100 between the first finger pattern 112 and the second finger pattern 122. Referring to FIG. 6, voltage is applied between the first pad 114 connected to the first finger pattern 112 and the second pad 124 connected to the second finger pattern 122. In one embodiment, the voltage applied to align the electric dipoles may be, for example, a direct current voltage of 0.1 kV to 2 kV.

As voltage is applied, the electric dipoles are aligned as shown, and the piezoelectric properties of the stress sensing pattern are activated. In the state where the electric dipoles are aligned, when stress is provided from the outside, as the electric dipoles are rearranged, a potential difference corresponding to the externally applied stress is formed between the first pad 114 and the second pad 124. Therefore, the magnitude of the externally applied stress can be detected by detecting the voltage formed between the first pad 130 and the second pad 140.

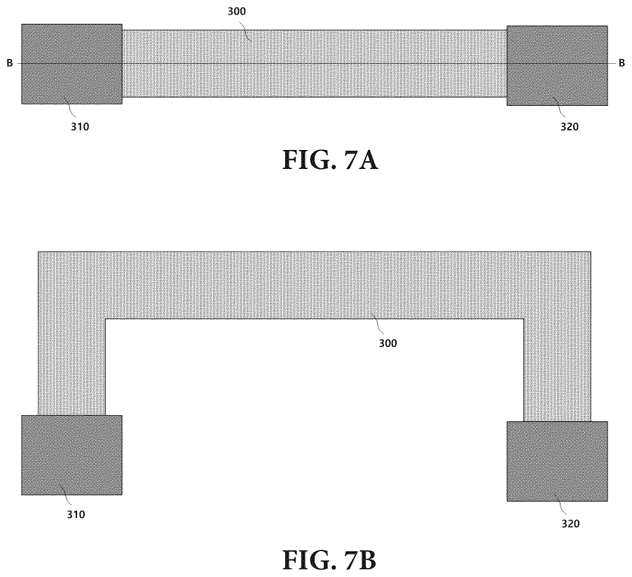

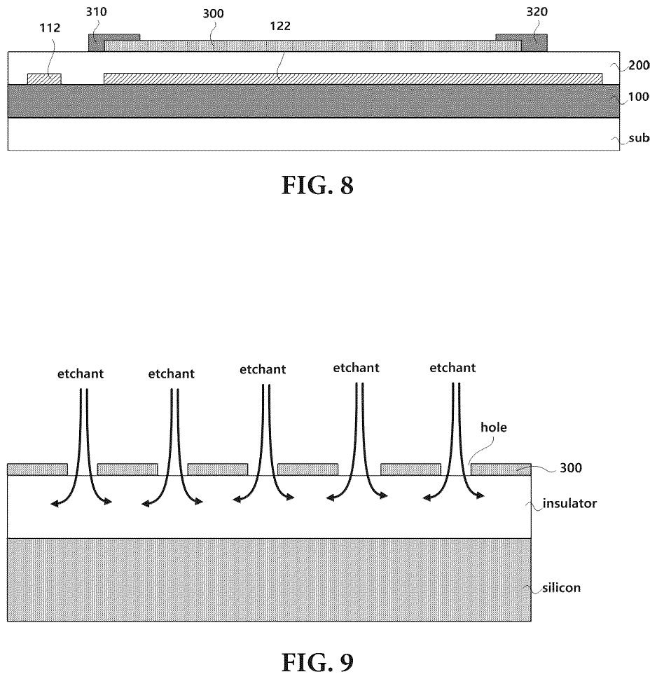

FIGS. 7Aa and 7B are top views illustrating states in which a strain sensing pattern 300 is formed on the surface of an interlayer separation film 200, and FIG. 8 is a cross-sectional view taken along line B-B of FIG. 7(a). Referring to FIGS. 7 and 8, a strain sensing pattern 300 is formed on the interlayer separation film 200.

In one embodiment, to maintain electrical insulation with the strain sensing pattern 300 formed on the upper part and adhesion with the strain sensing pattern 300, the strain sensing pattern may be formed before the interlayer separation film 200 is completely cured, and a subsequent curing process may be further performed.

As illustrated in the embodiment of FIG. 7A, the strain sensing pattern 300 may be formed as a straight line. In addition, as illustrated in the embodiment of FIG. 7B, the strain sensing pattern 300 may be patterned and formed in a U-shaped pattern.

Referring to FIGS. 7 and 8, a first metal pad 310 and a second metal pad 320 may be formed to measure the electrical resistance changed corresponding to the strain applied between one end and the other end of the strain sensing pattern 300.

In one embodiment, the strain sensing pattern 300 may be formed of a strain-sensitive material with a high gauge factor. The gauge factor is the degree to which resistivity changes when tensile force (strain) is applied in a direction parallel to the plane where the material is located. In this embodiment, the strain sensing pattern 300 may be formed of the above-mentioned strain-sensitive material, and the strain-sensitive material that can be used for the strain sensing pattern 300 may be, for example, one of a silicon nano-membrane pattern, a silicon carbide (SiC) pattern, a molybdenum disulfide (MoS₂) pattern, gallium nitride (GaN), a graphene pattern, a metal oxide pattern, or a metal pad.

In one embodiment, the step of forming the strain sensing pattern 300 may be performed by forming a material layer for forming the strain sensing pattern 300 on the interlayer separation film 200 and patterning the material layer.

In one embodiment, as a process of forming the strain sensing pattern 300, as illustrated in FIG. 9, a SOI (silicon-on-insulator) substrate with a silicon nano-membrane 302 formed is prepared, and a hole is formed by means such as dry-etching.

Subsequently, an etchant is provided through the hole, and the insulator layer is etched to obtain a silicon nano-membrane 300. In one embodiment, the silicon nano-membrane may be patterned as illustrated in the pattern of FIG. 7(b), and a metal pad may be formed at the end. The patterned silicon nano-membrane may be transferred to the upper part of the interlayer separation film 200 as illustrated in FIGS. 7 and 8.

In another example, the strain sensing pattern 300 may be formed of graphene. In one embodiment, a solvent containing graphene may be provided to a substrate by means such as spin coating, and after evaporating the solvent to form a graphene layer, the graphene layer is patterned to form a strain sensing pattern 300.

In yet another example, the strain sensing pattern 300 may be formed as a metal pattern. In one embodiment, a metal film may be formed by one or more methods among physical vapor deposition (PVD) including thermal evaporation, e-beam evaporation, and sputtering; chemical vapor deposition (CVD) including low pressure chemical vapor deposition (LPCVD), metal organic chemical vapor deposition (MOCVD), and plasma enhanced chemical vapor deposition (PECVD); and electrospinning, inkjet printing, spin coating, and spray coating, and this may be patterned to form a strain sensing pattern 300.

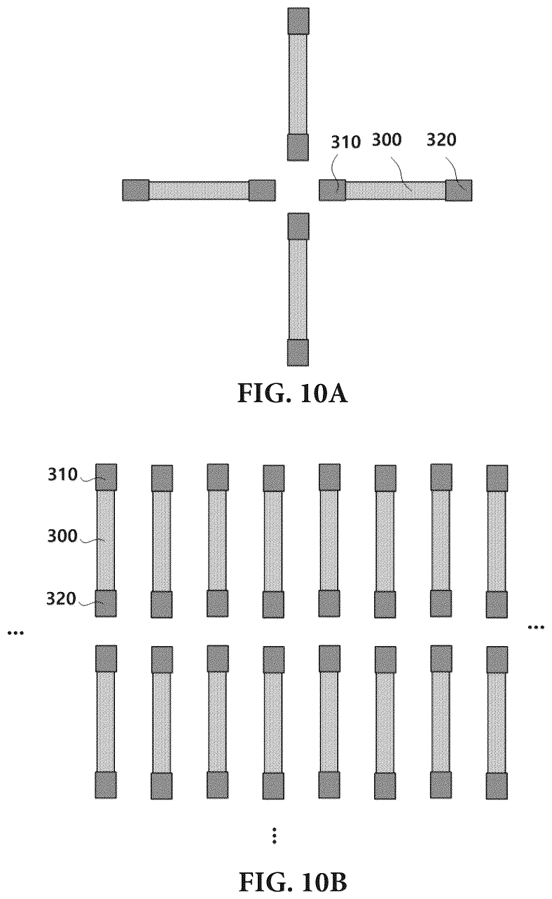

FIGS. 10A and 10B are views illustrating states in which a plurality of strain sensing patterns 300 are arranged. Referring to FIG. 10A, strain sensing patterns 300 may be arranged in directions perpendicular to each other to detect forces applied along orthogonal lateral and longitudinal axes. The illustrated embodiment shows two strain sensing patterns arranged horizontally and two strain sensing patterns arranged vertically, but according to an embodiment not shown, one strain sensing pattern may be arranged horizontally and one strain sensing pattern may be arranged vertically.

Referring to FIG. 10B, a plurality of strain sensing patterns 300 may be arranged in an array form. Eight strain sensing patterns arranged in two columns are illustrated, but in another embodiment not shown, more or fewer strain sensing patterns may be arranged in two or more columns or in one column.

Metal pads 310, 320 may be located at each end of the strain sensing pattern 300. In one embodiment, the metal pads 310, 320 may be formed by performing a step of forming a conductive metal layer such as gold, silver, copper, platinum, chromium, aluminum, titanium, or nickel, and a step of patterning the conductive metal layer through a semiconductor photo process.

The metal thin film layer may be formed by, for example, one or more methods among physical vapor deposition (PVD) including thermal evaporation, e-beam evaporation, and sputtering; chemical vapor deposition (CVD) including low pressure chemical vapor deposition (LPCVD), metal organic chemical vapor deposition (MOCVD), and plasma enhanced chemical vapor deposition (PECVD); and electrospinning, inkjet printing, spin coating, and spray coating.

The step of patterning the metal thin film layer may be performed through a photo process of a semiconductor process.

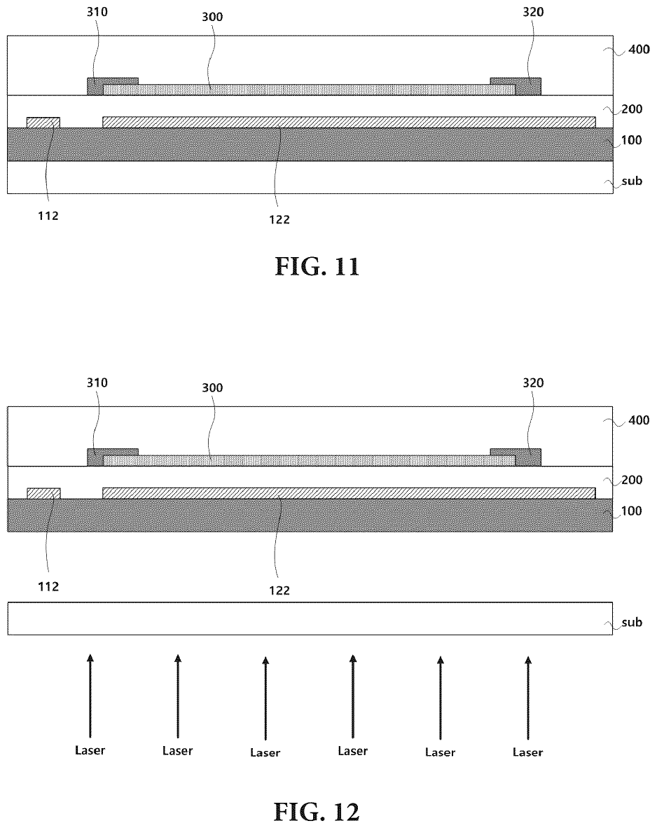

FIG. 11 is a schematic cross-sectional view illustrating a step of forming a protective layer 400 that encapsulates the strain sensing pattern 300. Referring to FIG. 11, the protective layer 400 prevents the penetration of impurities such as moisture and oxygen from the external environment, which could corrode the stress sensing pattern 100 and the strain sensing pattern 300. In one embodiment, the protective layer 400 may be formed as a layer of one or more of the same materials as the interlayer separation film 200 described above, such as polyimides, polydimethylsiloxane, polymethyl methacrylate, polyurethane, or photoresist. Therefore, the protective layer 400 and the interlayer separation film 200 may be formed of the same material, and may prevent corrosion and oxidation by separating the stress sensing pattern 100 and the strain sensing pattern 300 from the external environment, blocking the penetration of moisture and oxygen from the external environment.

FIG. 12 is a view illustrating a process of separating a substrate sub and a structure formed on the substrate sub. Referring to FIG. 12, the substrate sub and the structure formed on the substrate sub are separated by providing energy through the back side of the substrate sub. In one embodiment, energy may be provided by irradiating an excimer laser onto the back side of the substrate sub. The excimer laser may have, for example, a wavelength of 308 nm.

In one embodiment, the laser is provided through the back side of the substrate, and the laser may be irradiated in an off-focus state. In addition, the laser may be irradiated onto the back side of the substrate sub in a scanning manner.

In another example, the energy irradiated onto the substrate may be thermal energy, and interface separation between the substrate sub and the structure formed on the substrate may be performed by irradiating thermal energy.

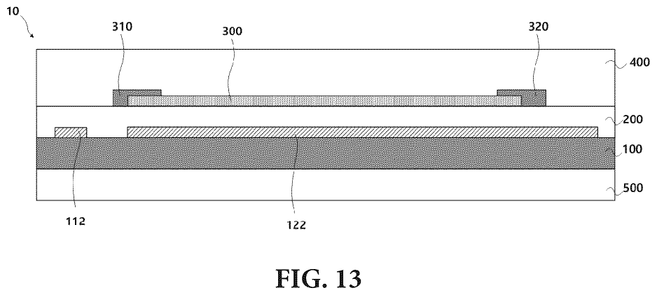

FIG. 13 is a cross-sectional view illustrating an example of a stress and strain detection device 10. Referring to FIG. 13, after separating the substrate sub, a protective layer 500 may be further formed on the exposed surface of the stress sensing layer 100. The protective layer 500 may be formed as a layer of one or more of polyimides, polydimethylsiloxane, polymethyl methacrylate, polyurethane, or photoresist as described above.

In addition, the interlayer separation film 200, the protective layer 400, and the protective layer 500 may be formed of the same material layer. Therefore, the interlayer separation film 200, the protective layer 400, and the protective layer 500 can isolate the stress sensing pattern 100 and the strain sensing pattern 300 from the external environment, blocking the penetration of moisture and oxygen from the external environment, thereby preventing corrosion and/or oxidation of the stress sensing pattern 100 and the strain sensing pattern 300.

Hereinafter, the stress and strain detection device 10 according to this embodiment will be described with reference to FIGS. 3, 7, and 13. Referring to FIGS. 3, 7, and 13, the stress and strain detection device 10 includes a stress sensing pattern 110 including interdigitated first finger patterns 110 and second finger patterns 120 (see FIG. 3), a strain sensing pattern 300 located on an interlayer separation film 200 covering the stress sensing pattern 110, and a protective layer 400 that isolates the strain sensing pattern 300 from the external environment. In the embodiment illustrated in FIG. 13, a protective layer 500 may be located below the stress sensing layer 100.

In one embodiment, the stress sensing pattern 100 detects pressure, which is stress applied in a direction perpendicular to the plane where the stress sensing pattern 100 is located, and a voltage corresponding to the detected pressure is formed between the first pad 114 and the second pad 124. In addition, the strain sensing pattern 300 is deformed according to tensile force, which is strain applied in a direction parallel to the plane where it is located, and its electrical resistance changes. Therefore, the applied strain can be detected by detecting the resistance between the first metal pad 310 and the second metal pad 320.

The stress sensing layer 100 is made of piezoelectric material that forms a voltage differential when pressure is applied, and the piezoelectric material may be one or more of lead zirconium titanate (PZT), barium titanate (BaTiO₃), polyvinylidene fluoride (PVDF), zinc oxide (ZnO), lithium niobate (LiNbO₃), lithium tantalate (LiTaO₃), lead titanate (PbTiO₃), titanium oxide (TiO₂), strontium titanate (SrTiO₃), and aluminum nitride (AlN). The strain sensing pattern 300 may be formed of strain-sensitive material including a silicon nano-membrane pattern, a silicon carbide (SiC) pattern, a molybdenum disulfide (MoS₂) pattern, gallium nitride (GaN), a graphene pattern, a metal oxide pattern, and a metal pad.

In addition, the stress and strain detection device 10 according to this embodiment has the advantage of being encapsulated with a protective layer to prevent corrosion and oxidation caused by the penetration of moisture and oxygen from the external environment, and having flexibility for free use.

Although the invention has been described with reference to exemplary embodiments illustrated in the drawings to help understand the invention, these are exemplary only, and those skilled in the art will understand that various modifications and equivalent other embodiments are possible from this. Therefore, the true technical protection scope of the invention should be determined by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A stress and strain detection device, comprising:
a stress sensing layer;
a stress sensing pattern positioned on the stress sensing layer;
an interlayer separation film covering the stress sensing pattern;
a strain sensing pattern positioned on the interlayer separation film; and
a protective layer that isolates the strain sensing pattern from the external environment, wherein the stress and strain detection device has flexibility.

18. The device of claim 17, wherein the stress sensing layer is a piezoelectric material layer that forms a voltage differential when pressure is applied, and the piezoelectric material is one or more of: lead zirconium titanate (PZT), barium titanate (BaTiO₃), polyvinylidene fluoride (PVDF), zinc oxide (ZnO), lithium niobate (LiNbO₃), lithium tantalate (LiTaO₃), lead titanate (PbTiO₃), titanium oxide (TiO₂), strontium titanate (SrTiO₃), and aluminum nitride (AlN).

19. The device of claim 17, wherein the stress sensing pattern includes: interdigitated first finger patterns and second finger patterns; a first pad connected to the first finger pattern; and a second pad connected to the second finger pattern.

20. The device of claim 17, wherein the strain sensing pattern is one of: a silicon nano-membrane pattern, a silicon carbide (SiC) pattern, a molybdenum disulfide (MoS₂) pattern, gallium nitride (GaN), a graphene pattern, a metal oxide pattern, and a metal pattern.

21. The device of claim 20, wherein the strain sensing pattern further includes metal pads located at one end and the other end.

22. The device of claim 17, wherein the strain sensing pattern is formed by being transferred from a silicon-on-insulator (SOI) substrate.

23. The device of claim 17, wherein the stress and strain detection device further includes: a protective layer that seals the exposed surface of the stress sensing pattern.

24. The device of claim 18, wherein the stress sensing layer is formed of crystallized piezoelectric material.

25. The device of claim 17, wherein the stress sensing layer includes: piezoelectric material whose piezoelectric properties are activated by the alignment of electric dipoles contained in the stress sensing layer when voltage is applied.

26. The device of claim 17, wherein the interlayer separation film and the protective layer are the same material layer.

27. The device of claim 17, wherein the strain sensing pattern is a metal thin film pattern, and the metal thin film pattern includes one of gold, silver, copper, platinum, chromium, aluminum, titanium, or nickel.

28. The device of claim 17, wherein the strain sensing pattern includes: a plurality of strain sensing patterns arranged in directions perpendicular to each other.

29. The device of claim 17, wherein the strain sensing pattern includes: a plurality of strain sensing patterns arranged in an array.
